(19) United States
(12) Patent Application Publication
(10) Pub. No.: US 2026/0074462 A1
(43) Pub. Date: Mar. 12, 2026

(54) AUTOMATIC DUST CAP FOR AUXILIARY POWER OUTLET

(71) Applicant: GM GLOBAL TECHNOLOGY OPERATIONS LLC, Detroit, MI (US)

(72) Inventors: Woo-Sung Bae, Northville, MI (US); Cesar Tiscareno, Macomb, MI (US); Scott Kendall Miller, Southfield, MI (US)

(73) Assignee: GM GLOBAL TECHNOLOGY OPERATIONS LLC, Detroit, MI (US)

(21) Appl. No.: 18/882,160

(22) Filed: Sep. 11, 2024

(51) Int. Cl. H01R 13/52; B60R 16/02; H01R 24/76; H01R 103/00

(52) U.S. Cl. CPC H01R 13/5213; B60R 16/02; H01R 24/76; H01R 2103/00; H01R 2201/26

(57) ABSTRACT

An auxiliary power port including a socket for receiving an electric power plug, a dust cover for covering an opening of the socket wherein the dust cover is moved to a retracted position during engagement of the electric power plug and moved to an engaged position after extraction of the electric power plug, a spring mechanism for applying a closing force to the dust cover, and a dampener for applying a dampening force to the dust cover such to reduce a rate of movement of the dust cover.

### INTRODUCTION

The present disclosure generally relates to automotive electrical systems and auxiliary power outlets, and more particularly relates to a method and apparatus to provide an automatically engaging dust cover for an automotive auxiliary power outlet having a spring loaded and dampened dust cap.

Modern vehicles are often equipped with multiple outlets to accommodate the charging needs of smartphones, tablets, and other portable electronics. Moreover, these outlets have become integral to powering in-car accessories and supporting advanced vehicle systems. The integration of USB ports and wireless charging technologies further exemplifies the power outlet's adaptation to the evolving demands of contemporary drivers. The automotive auxiliary power outlet traces its origins to the early 20th century, provided as a convenience to automobile drivers and passengers. Originally, these auxiliary power outlets included removeable heating elements, but their utility quickly transcended this singular purpose, becoming a ubiquitous feature in automobiles by the mid-20th century. As technological advancements unfolded and personal electronics proliferated, the power outlet's role expanded exponentially.

Originally, the removable heating element was retained in the auxiliary power outlet when not engaged, thereby operating as a barrier to prevent dirt and other contaminants from entering the auxiliary power outlet. After the decline in popularity of the removable heating elements, these automotive auxiliary power outlets have been typically equipped with dust covers to protect the electrical contacts from environmental contaminants. These covers serve as a crucial barrier against the ingress of dust, debris, and moisture, which can compromise the outlet's functionality. By preventing corrosion and oxidation, dust covers contribute to the outlet's reliability and longevity, ensuring consistent power delivery to connected devices. Additionally, these covers maintain the aesthetic appeal of the vehicle's interior by preserving the outlet's clean appearance.

Current automotive auxiliary power outlets often feature a spring attached cap, which while effective in protecting the port from contaminants. It is desirable to improve efficiency of the current operation of automotive auxiliary power outlets. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle control methods and systems and related electrical systems for provisioning vehicle auxiliary power systems, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for providing an automatically opening and closing auxiliary power outlet cover having at least one spring loaded baffle for sealing an opening of the auxiliary power outlet when a power plug is not engaged and wherein the spring loaded baffle includes a dampener which is compressed when a power plug is engaged in the auxiliary power outlet and when the power plug is disengaged. The dampener creates a resistance to the spring loaded baffle, slowing the speed of the spring loaded baffle as it returns to the sealed position.

In accordance with an aspect of the present disclosure, an auxiliary power port including a socket for receiving an electric power plug, a dust cover for covering an opening of the socket wherein the dust cover is moved to a retracted position during engagement of the electric power plug and moved to an engaged position after extraction of the electric power plug, a spring mechanism for applying a closing force to the dust cover, and a dampener for applying a dampening force to the dust cover such to reduce a rate of movement of the dust cover.

In accordance with another aspect of the present disclosure, wherein the spring mechanism is a trigger linkage for delivering a bidirectional triggering force.

In accordance with another aspect of the present disclosure, wherein the spring mechanism further includes a tension spring damper.

In accordance with another aspect of the present disclosure, wherein the spring mechanism is a three part trigger linkage.

In accordance with another aspect of the present disclosure, wherein the rate of movement of the dust cover is reduced such that the dust cover does not contact the power plug during extraction of the power plug from the socket.

In accordance with another aspect of the present disclosure, wherein the dust cover is a double door dust cover and wherein the spring mechanism applies a closing force to the double door dust cover and wherein the dampener applies a damping force to the double door dust cover.

In accordance with another aspect of the present disclosure, wherein the dust cover includes a first door and a second door and the spring mechanism applies a closing force to the first door dust cover and wherein the dampener applies a damping force to the first door dust cover.

In accordance with another aspect of the present disclosure, wherein the dust cover includes a first door and a second door a second spring mechanism and a second dampener and wherein the spring mechanism applies a closing force to the first door dust cover and wherein the dampener applies a damping force to the first door dust cover and the second spring mechanism applies a closing force to the second door dust cover and wherein the second dampener applies a damping force to the second door dust cover.

In accordance with another aspect of the present disclosure, wherein the spring mechanism is mechanically coupled to the socket by a second dampener such that during extraction of the power plug, the second dampener applied a force to the dust cover to initiate a closing motion of the dust cap.

In accordance with another aspect of the present disclosure, a method of providing an auxiliary power port for vehicular applications including receiving, by a socket, an electric power plug, opening a dust cover for covering an opening of the socket in response to an engagement of the electric power plug into the socket wherein the dust cover is moved to a retracted position during engagement of the electric power plug, and closing the dust cover in response to an extraction of the electric power plug by a spring mechanism for applying a closing force to the dust cover and a dampener for applying a dampening force to the dust cover such to reduce a rate of movement of the dust cover.

In accordance with another aspect of the present disclosure, wherein the spring mechanism is a trigger linkage for delivering a bidirectional triggering force.

In accordance with another aspect of the present disclosure, wherein the spring mechanism further includes a tension spring damper for regulating a rate of expansion of the spring mechanism.

In accordance with another aspect of the present disclosure, wherein the spring mechanism is a three part trigger linkage.

In accordance with another aspect of the present disclosure, wherein the rate of movement of the dust cover is reduced such that the dust cover does not contact the power plug during extraction of the power plug from the socket.

In accordance with another aspect of the present disclosure, wherein the dust cover is a double door dust cover and wherein the spring mechanism applies a closing force to the double door dust cover and wherein the dampener applies a damping force to the double door dust cover.

In accordance with another aspect of the present disclosure, wherein the dust cover includes a first door and a second door and the spring mechanism applies a closing force to the first door dust cover and wherein the dampener applies a damping force to the first door dust cover.

In accordance with another aspect of the present disclosure, wherein the dust cover includes a first door and a second door a second spring mechanism and a second dampener and wherein the spring mechanism applies a closing force to the first door dust cover and wherein the dampener applies a damping force to the first door dust cover and the second spring mechanism applies a closing force to the second door dust cover and wherein the second dampener applies a damping force to the second door dust cover

In accordance with another aspect of the present disclosure, wherein the closing of the dust cover in response to the extraction of the electric power plug is delayed by a predetermined time duration by a delay device coupled between the spring mechanism and the socket.

In accordance with another aspect of the present disclosure, an auxiliary power port for a vehicular application including a socket for receiving an electric power plug wherein the socket includes a conductive portion coupled to an electric power supply and a non-conductive portion for mounting the auxiliary power port into a vehicle surface, a dust cover for covering an opening of the socket wherein the dust cover is moved to a retracted position during engagement of the electric power plug and moved to an engaged position after extraction of the electric power plug, a spring mechanism for applying a closing force to the dust cover, and a dampener for applying a dampening force to the dust cover such to reduce a rate of movement of the dust cover.

In accordance with another aspect of the present disclosure, wherein the spring mechanism is a three part trigger linkage for delivering a bidirectional triggering force including a tension spring damper for regulating a rate of expansion of the spring mechanism.

### BRIEF DESCRIPTION OF THE DRAWINGS

The exemplary embodiments will hereinafter be described in conjunction with the following drawing figures, wherein like numerals denote like elements, and wherein:

FIG. 1 shows an auxiliary power port and a power plug in accordance with various embodiments;

FIG. 2 shows a side view representation of an auxiliary power port in accordance with various embodiments;

FIG. 3 shows an auxiliary power port with an engaged power plug in accordance with various embodiments;

FIG. 4 shows a front view representation of an auxiliary power port with engaged power plug in accordance with various embodiments; and

FIG. 5 shows a control system associated with a vehicle in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

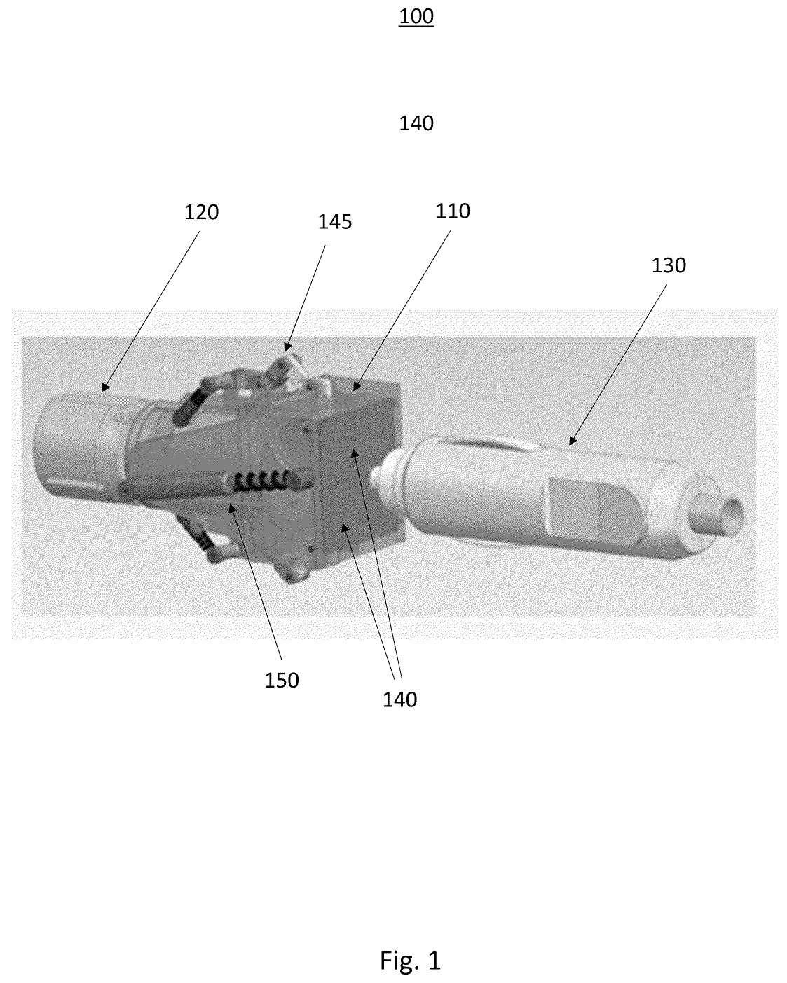

With reference to FIG. 1, an exemplary application 100 of an auxiliary power port 110 and a power plug 130 in accordance with various embodiments is shown. In general, the application 100 can include an auxiliary power port 110, socket 120, power plug 130. In accordance with some exemplary embodiments, the auxiliary power port 110 is configured with at least one dust cover 140 and at least one dampener 150. While the present embodiment is described in terms of the auxiliary power port 110, the described methods and system can be employed in other sockets or ports, such as universal serial bus (USB) ports, audio jacks, 120/240 volt outlets, video inputs and outputs such as high-definition multimedia interface (HDMI), S-video, VGA, on board diagnostic II (OBD II) and any other data, video, power or audio port.

Existing dust protection solutions for auxiliary power ports in vehicles, such as spring caps and non-spring caps, typically require manual intervention. Push caps, while offering one-handed operation, do not possess automatic closing, leaving them vulnerable to dust and debris accumulation. The exemplary auxiliary power port 110 is configured as a self-contained, automated solution. When the power plug 130 is inserted, the dust cover 140 seamlessly opens to accommodate the connection, preventing any contact between the dust cover 140 and the power plug 130. Upon removal, a spring mechanism 145 initiates the closing process, which is deliberately slowed down by the dampener 150 to ensure smooth operation and avoid damage to the power plug 130 or the auxiliary power port 110. This mechanism effectively safeguards the auxiliary power port 110 from contaminants while providing users with a hassle-free experience.

In some exemplary embodiments, a double-door dust cover 140 configuration is employed for optimal space utilization within the vehicle's interior. The double door dust cover 140 mechanism hinges on a strategically placed spring dampener 150 that facilitates full dust cover 140 opening upon power plug 130 insertion. This dampener 150 is configured to maintain the dust cover 140 in an open state until the power plug 130 is extracted. The spring mechanism 145, such as a trigger linkage system, can govern the motion of the dust cover 140, activated sequentially by both the plugging and unplugging actions. In some exemplary embodiments, this spring mechanism 145 can incorporate a dual-spring configuration: a compression spring for the primary opening and closing function, and a tension spring to regulate the closing speed. In some exemplary embodiments, the tension spring can exert a greater force than the compression spring to ensure consistent and complete cap closure.

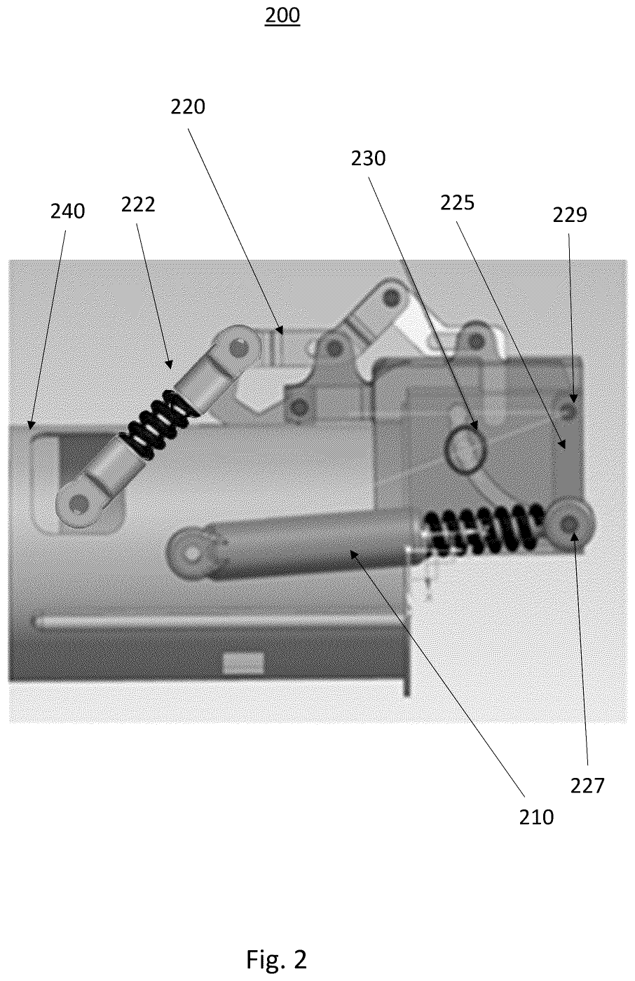

Turning now to FIG. 2, a side view representation of an auxiliary power port 200 in accordance with various embodiments. The illustrated auxiliary power port 200 is shown with the 12 volt socket 240, with a power plug disengaged and the dust cover 225 in the closed position. In the closed configuration, the dampener 210 is shown in the fully extended position. The spring mechanism 220 is shown in the closed position with the spring mechanism spring 225 being uncompressed. In some exemplary embodiments, the dampener 225 can include a protrusion 227 which is rigidly affixed to the dust cover 225 at a location distal from a rotation point 229 of the dust cover 225. The protrusion 227 can be configured to be mechanically affixed to an extendible portion of the dampener 210 such that once the power plug is disengaged from the auxiliary power port 200, the dampener 210 applies a force to the protrusion 227 to regulate a closing rate of the dust cover 225. In some exemplary embodiments, when the power plug is disengaged, the spring mechanism 220 asserts a closing force on the dust cover 225 and the dampener 210 applies an opposing force to the closing force. The dampener 210 can be regulated by a fluid, such as liquid or gas, being forced through orifices as the dampener 210 is compressed or extended. This controlled flow of fluid through the orifices creates resistance to the dampener's movement and regulates the closing speed of the dust cover 225. In some exemplary embodiments, the protrusion 227 can move through a slot 229 in the auxiliary power plug as the dust cover 225 is opened and closed. This slot 229 can advantageously regulate the movement of the dust cover 225 and can reduce stress at the rotation point 229 at the dust cover 225. In addition, the shape of the slot 229 can regulate the pressure applied to the protrusion 227 by the dampener 210. In the illustrated example, when the power plug is extracted, the protrusion 227 moves substantially vertically in the slot 229. Thus, only a smaller portion of the regulating force of the dampener 210 is used to regulate the movement of the dust cover 225. As the protrusion 227 moves further in the slot 230 as the dust cover 225 closes, a larger portion of the regulating force of the dampener 210 is applied to the protrusion along the direction of movement.

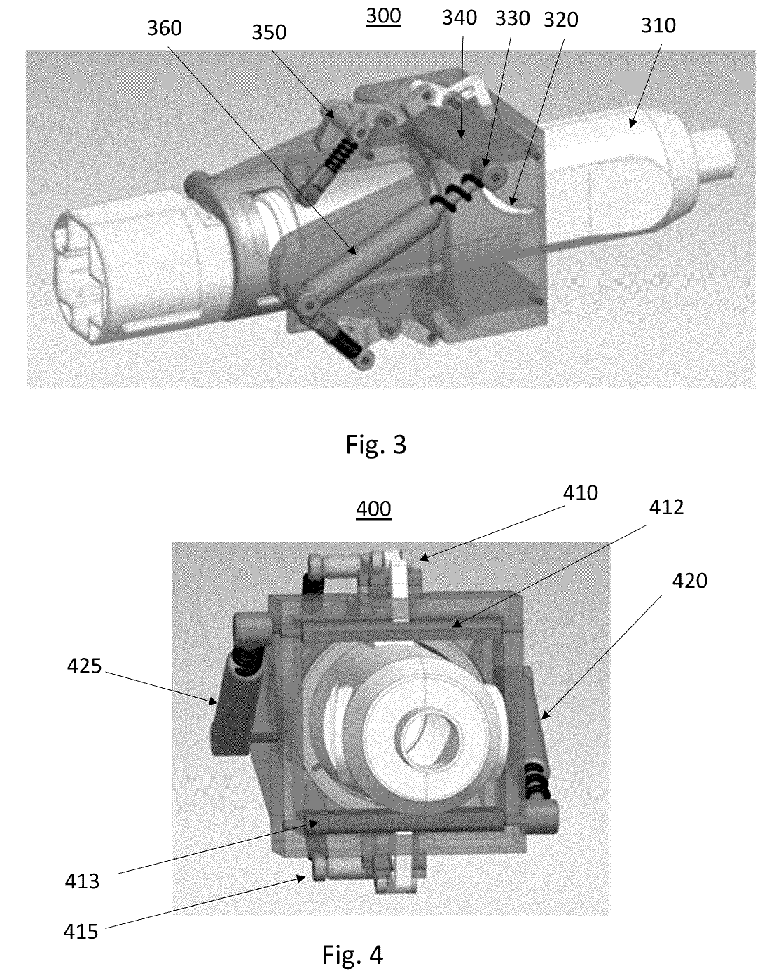

Turning now to FIG. 3 is illustrative of the auxiliary power port 300 with an engaged power plug 310 in accordance with various embodiments. With the power plug 310 engaged into the auxiliary power port 200, the dust cover 340 is pushed into the open position by the inserted power plug 310. As the dust cover 340 is pushed into the open position, the protrusion 330 mechanically coupled to the dust cover 340 is moved within the slot 320, thereby compression the dampener 360. In addition, with the pushing of the dust cover 340 into the open position, the spring mechanism 350 is compressed.

Turning now to FIG. 4 shows a front view representation of an auxiliary power port 400 with engaged power plug 410 in accordance with various embodiments. In some exemplary embodiments, the auxiliary power port can have a plurality of one dust covers 412, 413. The auxiliary power port 400 is shown with the engaged power plug 410 and the first dust cover 412 and the second dust cover 413 shown in the open position. The exemplary auxiliary power port 400 is further shown with a first spring mechanism 410 and a first dampener 425 mechanically coupled to the first dust cover 412 and a second spring mechanism 415 and a second dampener 420 mechanically coupled to the second dust cover 413.

In some exemplary embodiments, the force applied by the first and second spring mechanisms 410, 415 and the dampening force of the first and second dampeners 420, 425 are chosen such that the first dust cover 412 and second dust cover 413 close at a rate slow enough to prevent the power plug 410 from catching on the first or second spring dust covers 412, 413 when the power plug 410 is being disengaged at a predetermined extraction rate.

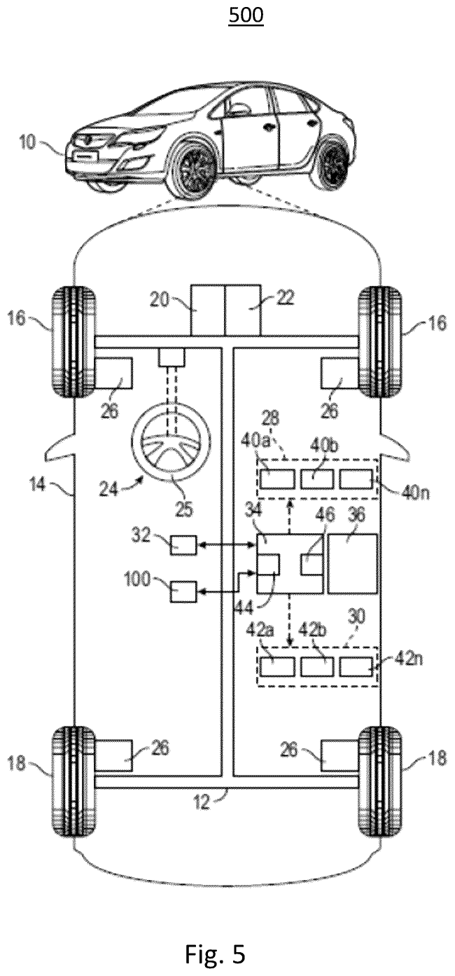

With reference to FIG. 5, a control system 500 is associated with a vehicle 10 (also referred to herein as a “vehicle”) in accordance with various embodiments. In general, the control system (or simply “system”) 500 provides for control of various actions of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 5).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 5, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous APC/SPARK prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 5, such as various doors, a trunk, and cabin features such as air, music, lighting, touch-screen display components (such as those used in connection with navigation systems), and the like.

The data storage device 32 stores data for use in automatically controlling the vehicle 10, including the storing of control data. The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 can include at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 5, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other vehicles (“V2V” communication), infrastructure (“V2I” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers, such as a user device 54, and/or one or more sources of remote information (e.g., GPS data, traffic information, weather information, and so on).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An auxiliary power port comprising:
a socket for receiving an electric power plug;
a dust cover for covering an opening of the socket wherein the dust cover is moved to a retracted position during engagement of the electric power plug and moved to an engaged position after extraction of the electric power plug;
a spring mechanism for applying a closing force to the dust cover; and
a dampener for applying a dampening force to the dust cover such to reduce a rate of movement of the dust cover.

2. The auxiliary power port of claim 1, wherein the spring mechanism is a trigger linkage for delivering a bidirectional triggering force.

3. The auxiliary power port of claim 1, wherein the spring mechanism further includes a tension spring damper.

4. The auxiliary power port of claim 1, wherein the spring mechanism is a three part trigger linkage.

5. The auxiliary power port of claim 1, wherein the rate of movement of the dust cover is reduced such that the dust cover does not contact the power plug during extraction of the power plug from the socket.

6. The auxiliary power port of claim 1, wherein the dust cover is a double door dust cover and wherein the spring mechanism applies a closing force to the double door dust cover and wherein the dampener applies a damping force to the double door dust cover.

7. The auxiliary power port of claim 1, wherein the dust cover includes a first door and a second door and the spring mechanism applies a closing force to the first door dust cover and wherein the dampener applies a damping force to the first door dust cover.

8. The auxiliary power port of claim 1, wherein the dust cover includes a first door and a second door a second spring mechanism and a second dampener and wherein the spring mechanism applies a closing force to the first door dust cover and wherein the dampener applies a damping force to the first door dust cover and the second spring mechanism applies a closing force to the second door dust cover and wherein the second dampener applies a damping force to the second door dust cover.

9. The auxiliary power port of claim 1, wherein the spring mechanism is mechanically coupled to the socket by a second dampener such that during extraction of the power plug, the second dampener applied a force to the dust cover to initiate a closing motion of the dust cap.

10. A method of providing an auxiliary power port for vehicular applications comprising:
receiving, by a socket, an electric power plug;
opening a dust cover for covering an opening of the socket in response to an engagement of the electric power plug into the socket wherein the dust cover is moved to a retracted position during engagement of the electric power plug; and
closing the dust cover in response to an extraction of the electric power plug by a spring mechanism for applying a closing force to the dust cover and a dampener for applying a dampening force to the dust cover such to reduce a rate of movement of the dust cover.

11. The method of providing the auxiliary power port of claim 10, wherein the spring mechanism is a trigger linkage for delivering a bidirectional triggering force.

12. The method of providing the auxiliary power port of claim 10, wherein the spring mechanism further includes a tension spring damper for regulating a rate of expansion of the spring mechanism.

13. The method of providing the auxiliary power port of claim 10, wherein the spring mechanism is a three part trigger linkage.

14. The method of providing the auxiliary power port of claim 10, wherein the rate of movement of the dust cover is reduced such that the dust cover does not contact the power plug during extraction of the power plug from the socket.

15. The method of providing the auxiliary power port of claim 10, wherein the dust cover is a double door dust cover and wherein the spring mechanism applies a closing force to the double door dust cover and wherein the dampener applies a damping force to the double door dust cover.

16. The method of providing the auxiliary power port of claim 10, wherein the dust cover includes a first door and a second door and the spring mechanism applies a closing force to the first door dust cover and wherein the dampener applies a damping force to the first door dust cover.

17. The method of providing the auxiliary power port of claim 10, wherein the dust cover includes a first door and a second door a second spring mechanism and a second dampener and wherein the spring mechanism applies a closing force to the first door dust cover and wherein the dampener applies a damping force to the first door dust cover and the second spring mechanism applies a closing force to the second door dust cover and wherein the second dampener applies a damping force to the second door dust cover.

18. The method of providing the auxiliary power port of claim 10, wherein the closing of the dust cover in response to the extraction of the electric power plug is delayed by a predetermined time duration by a delay device coupled between the spring mechanism and the socket.

19. An auxiliary power port for a vehicular application comprising:
a socket for receiving an electric power plug wherein the socket includes a conductive portion coupled to an electric power supply and a non-conductive portion for mounting the auxiliary power port into a vehicle surface;
a dust cover for covering an opening of the socket wherein the dust cover is moved to a retracted position during engagement of the electric power plug and moved to an engaged position after extraction of the electric power plug;
a spring mechanism for applying a closing force to the dust cover; and
a dampener for applying a dampening force to the dust cover such to reduce a rate of movement of the dust cover wherein the rate of movement of the dust cover is reduced such that the dust cover does not contact the power plug during extraction of the power plug from the socket.

20. The auxiliary power port for the vehicular application of claim 19, wherein the spring mechanism is a three part trigger linkage for delivering a bidirectional triggering force including a tension spring damper for regulating a rate of expansion of the spring mechanism.
